(19) United States
(12) Patent Application Publication
(10) Pub. No.: US 2023/0112652 A1
(43) Pub. Date: Apr. 13, 2023

(54) ELECTROCHEMICAL CELL HAVING LITHIUM METAL ANODE AND MULTILAYERED CATHODE

(71) Applicant: EnPower, Inc., Indianapolis, IN (US)

(72) Inventor: Adrian YAO, Palo Alto, CA (US)

(21) Appl. No.: 17/935,459

(22) Filed: Sep. 26, 2022

Related U.S. Application Data
(60) Provisional application No. 63/298,949, filed on Jan. 12, 2022.
(60) Provisional application No. 63/248,188, filed on Sep. 24, 2021.

(51) Int. Cl. H01M 4/40; H01M 50/46; H01M 4/485; H01M 4/58; H01M 4/66; H01M 4/70; H01M 50/417; H01M 50/434; H01M 50/491; H01M 4/36; H01M 10/0525

(52) U.S. Cl. CPC H01M 4/405; H01M 4/70; H01M 4/366; H01M 4/485; H01M 4/661; H01M 4/5825; H01M 10/0525; H01M 50/46; H01M 50/417; H01M 50/434; H01M 50/491; H01M 2004/027

(57) ABSTRACT

An electrochemical cell including a lithium metal anode and a multilayered cathode includes a lithium metal anode laminated, electroplated, or alloyed onto a first current collector, a multilayered cathode layered onto a second current collector, and a separator disposed between the lithium metal anode and the multilayered cathode. In some examples, the lithium metal anode is electroplated onto the first current collector when the electrochemical cell is charged and stored within the multilayered cathode when the electrochemical cell is discharged. In some examples, multilayered cathode further includes an integrated ceramic separator.

### CROSS-REFERENCES

The following applications and materials are incorporated herein, in their entireties, for all purposes: U.S. Provisional Pat. Application Serial No. 63/248,188, filed Sep. 24, 2021 and U.S. Provisional Pat. Application Serial No. 63/298,949, filed Jan. 12, 2022.

### FIELD

This disclosure relates to systems and methods for electrochemical cells. More specifically, the disclosed embodiments relate to electrochemical cells having multilayered electrodes.

### INTRODUCTION

Environmentally friendly sources of energy have become increasingly critical, as fossil fuel-dependency becomes less desirable. Most non-fossil fuel energy sources, such as solar power, wind, and the like, require some sort of energy storage component to maximize usefulness. Accordingly, battery technology has become an important aspect of the future of energy production and distribution. Most pertinent to the present disclosure, the demand for secondary (i.e., rechargeable) batteries has increased. Various combinations of electrode materials and electrolytes are used in these types of batteries, such as lead acid, nickel cadmium (NiCad), nickel metal hydride (NiMH), nickel manganese cobalt oxide (NMC), nickel cobalt aluminum oxide (NCA), lithium ion (Li-ion), and lithium-ion polymer (Li-ion polymer).

### SUMMARY

The present disclosure provides systems, apparatuses, and methods relating to electrochemical cells having lithium metal anodes and multilayered cathodes.

In some examples, an electrochemical cell according to aspects of the present disclosure includes: an anode including: a first current collector, and lithium metal, wherein the lithium metal is configured to act as an anode active material; a cathode including: a second current collector, a first cathode active material layer layered onto the second current collector, the first cathode active material layer comprising a first plurality of active material particles adhered together by a first binder, and a second cathode active material layer layered onto the first cathode active material layer, the second cathode active material layer comprising a second plurality of active material particles adhered together by a second binder; and a separator disposed between the anode and the cathode.

In some examples, an electrochemical cell according to aspects of the present disclosure includes: a first current collector comprising copper foil; a second current collector; a first cathode active material layer layered onto the second current collector, the first cathode active material layer comprising a first plurality of active material particles adhered together by a first binder; a second cathode active material layer layered onto the first cathode active material layer, the second cathode active material layer comprising a second plurality of active material particles adhered together by a second binder; and a separator disposed adjacent to the second cathode active material layer; wherein the electrochemical cell is configured to transition between: (a) a charged state, wherein a lithium metal anode layer is electroplated onto the first current collector and disposed between the first current collector and the separator, and (b) a discharged state, wherein the first current collector is contacting the separator, and wherein lithium ions reside within the first and second cathode active material layers.

In some examples, an electrochemical cell according to aspects of the present disclosure includes: an anode including a lithium metal anode and a first current collector; and a cathode including: a first cathode active material layer layered onto a second current collector, the first cathode active material layer comprising a first plurality of active material particles adhered together by a first binder; a second cathode active material layer layered onto the first cathode active material layer, the second cathode active material layer comprising a second plurality of active material particles adhered together by a second binder; and an integrated ceramic separator layer layered onto the second cathode active material layer, the integrated ceramic separator layer comprising a plurality of inorganic ceramic separator particles adhered together by a third binder.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic view of an illustrative electrochemical cell, according to aspects of the present disclosure.

FIG. 2 is a schematic view of a first illustrative electrochemical cell having a multilayered cathode and a lithium metal anode, according to aspects of the present disclosure.

FIG. 3 is a schematic view of a second illustrative electrochemical cell having a multilayered cathode and a lithium metal anode, according to aspects of the present disclosure.

FIG. 4 is a schematic view of a third illustrative electrochemical cell having a multilayered cathode and a lithium metal anode, according to aspects of the present disclosure.

FIG. 5 is a schematic sectional view of an illustrative interlocking layer configured to be disposed between a first layer and a second layer of the multilayered cathode of FIG. 4.

FIG. 6 is a schematic view of a first illustrative electrochemical cell having a multilayered cathode, a lithium metal anode, and an integrated ceramic separator, according to aspects of the present disclosure.

FIG. 7 is a schematic view of a second illustrative electrochemical cell having a multilayered cathode, a lithium metal anode, and an integrated ceramic separator, according to aspects of the present disclosure.

FIG. 8 is a flow chart depicting steps of an illustrative method for manufacturing a multilayered cathode according to aspects of the present disclosure.

FIG. 9 is a sectional view of an illustrative electrode undergoing a calendering process in accordance with aspects of the present disclosure.

FIG. 10 is a schematic diagram of an illustrative manufacturing system including two die slots suitable for manufacturing electrodes and electrochemical cells of the present disclosure.

FIG. 11 is a schematic diagram of an illustrative manufacturing system including three die slots suitable for manufacturing electrodes and electrochemical cells of the present disclosure.

### DETAILED DESCRIPTION

Various aspects and examples of electrochemical cells having lithium metal anodes and multilayered cathodes, as well as related methods, are described below and illustrated in the associated drawings. Unless otherwise specified, an electrochemical cell in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Coupled” means connected, either permanently or releasably, whether directly or indirectly through intervening components.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“NCA” means Lithium Nickel Cobalt Aluminum Oxide (LiNiCoAlO₂).

“NMC” or “NCM” means Lithium Nickel Cobalt Manganese Oxide (LiNiCoMnO₂).

“LFP” means Lithium Iron Phosphate (LiFePO₄).

“LMO” means Lithium Manganese Oxide (LiMn₂O₄).

“LNMO” means Lithium Nickel Manganese Spinel (LiNi_{0.5}Mn_{1.5}O₄).

“LCO” means Lithium Cobalt Oxide (LiCoO₂).

“LTO” means Lithium Titanate (Li₂TiO₃).

“NMO” means Lithium Nickel Manganese Oxide (Li(Ni_{0.5}Mn_{0.5})O₂).

“LLZO” means Lithium Lanthanum Zirconium Oxide (Li₇La₃Zr₂O₁₂).

“LLZTO” means Lithium Lanthanum Zirconium Tantalum Oxide (Li₆.₄La₃Zri.₄Tao.₆O₁₂).

“EC” means Ethylene Carbonate ((CH₂O)₂CO).

“EMC” means Ethyl Methyl Carbonate (C₄H₈O₃).

“DEC” means Diethyl Carbonate (C₅H₁₀O₃).

“DMC” means Dimethyl Carbonate (OC(OCH₃)₂).

“LiFSI” means Lithium bis(fluorosulfonyl)imide (LiC₂NO₄F₆S₂).

“LiTFSI” means Lithium bis(trifluoromethanesulfonyl)imide (LiC₂F₆NO₄S₂).

“DME” means (1,2-dimethoxyethane).

“TEP” means Triethyl Phosphate (C₂H₅)₃PO₄.

“BTFE” means (bis(2,2,2-trifluoroethyl) ether.

“TFTFE” means 1,1,2,2,- Tetrafluoroethyl 2,2,2,-trifluoroethyl ether.

“PC” means Propylene Carbonate (C₄H₆O₃).

“PVDF-HFP” means (poly(vinylidene fluoride - hexafluoropropylene)).

“Tortuosity” refers to the overall expediency of paths through an electrode. In some examples, the tortuosity of a path through the electrode may refer to the ratio of actual flow path length to the straight distance between the ends of the flow path within the electrode, also known as the arc-chord ratio. In some examples, the overall tortuosity of an electrode may be described by the equation:

$$\frac{τ}{ε} = \frac{{ρ}_{e f f}}{{ρ}_{0}} = \frac{{κ}_{0}}{{κ}_{e f f}} = \frac{{D}_{0}}{{D}_{e f f}} = {N}_{M}$$

where _{T} is the tortuosity factor; ε is the porosity; N_{M} is the MacMullin number; p₀, _{K0}, and D₀ are, respectively, the “intrinsic” electrical resistivity (Ω m), conductivity (S m⁻¹) and diffusion coefficient (m²s⁻¹) of the electrolyte; and p_{eff}, _{Keff}, and D_{eff} are the observed “effective” values resulting from the transport constraints imposed by a porous and tortuous microstructure.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, an electrochemical cell in accordance with the present teachings includes a metallic lithium anode (AKA lithium metal anode) and a cathode having a multilayered porous architecture (AKA a multilayer cathode). The inclusion of lithium metal anodes in electrochemical cells facilitates the use of cathodes with higher mass/capacity loadings. However, higher mass cathodes (and therefore thicker cathodes) suffer from mass transport limitations, which are alleviated through the use of multilayer electrode architectures to facilitate improved rate performance.

In some examples, the metallic lithium anode includes metallic lithium laminated to a copper anode current collector to form the metallic lithium anode. In some examples, metallic lithium is electroplated directly from lithium stored in the cathode in an “anode-free” electrochemical cell configuration where no excess lithium is used. In some examples, lithium metal is directly alloyed with a Li-Mg type foil current collector, forming the metallic lithium anode.

In some examples, the multilayered cathode comprises a first cathode layer including a first plurality of active material particles adhered together by a first binder, and a second cathode layer including a second plurality of active material particles adhered together by a second binder. The first cathode layer may be layered onto and directly contacting a cathode current collector, which may comprise a metal foil. The first and second pluralities of active material particles may comprise any suitable transition metal oxide materials, such as NMC (lithium nickel manganese cobalt oxide), LCO (lithium cobalt oxide), LFP (lithium iron phosphate), and/or the like. In some examples, the multilayered cathode has a tortuosity gradient, having lower tortuosity in regions of the multilayered cathode disposed closer to the separator and higher tortuosity in regions of the multilayered cathode disposed closer to the current collector. In some examples, the multilayered cathode has a porosity gradient, having higher pore volumes in regions of the multilayered cathode disposed closer to the separator and lower pore volumes in regions of the multilayered cathode disposed closer to the current collector. In some examples, the multilayered cathode has a particle size gradient, wherein particle sizes of cathode particles disposed closer to the separator are larger than particle sizes of cathode particles disposed closer to the current collector.

Pores of the multilayered cathode are filled (AKA impregnated) with a liquid and/or a gel electrolyte, which facilitates the transport of ions between the anode and the cathode. In some examples, pores of the multilayered cathode are filled with an organic carbonate electrolyte with dilute salt concentration (e.g., 1.0-1.5 M LiPF6 in EC(ethylene carbonate)/EMC(ethyl methyl carbonate)/DEC(diethyl carbonate)/DMC(dimethyl carbonate) carbonate base solvent with additives, etc.). In some examples, pores of the multilayered cathode are filled with ionic liquids, such as 0.3 M LiTFSI in PY14TFSI (N-butyl-N-methyl-pyrrolidiniumbis(trifluoromethanesulfonyl)imide), and/or the like. In some examples, pores of the multilayered cathode are filled with a solvent-in-salt electrolyte, such as >3 M LiFSI/LiTFSI in DME (1,2-dimethoxyethane) or DMC (dimethyl carbonate), and/or the like. In some examples, pores of the multilayered cathode are filled with local high concentration electrolytes (LHCEs), such as LiFSI/LiTFSI in DME (dimethoxyethane)/DMC (dimethyl carbonate), TEP (triethyl phosphate), and/or the like, and subsequently diluted with electrochemically inactive fluorinated ethers, such as BTFE (bis(2,2,2-trifluoroethyl) ether, TFTFE (1,1,2,2-Tetrafluoroethyl 2,2,2-trifluoroethyl ether), and/or the like. In some examples, pores of the multilayered cathode are filled with a gel electrolyte (such as LiPF6 in EC/EMC/PC(propylene carbonate)/DEC/DMC in PVDF-HFP (poly(vinylidene fluoride - hexafluoropropylene), etc.) copolymer matrix.

A separator is disposed between the metallic lithium anode and the multilayered cathode. In some examples, the separator is a porous polyolefin film permeated with liquid electrolyte, such as electrolytes described above. In some examples, the separator is a solid oxide-based lithium-ion conductor, such as garnet-type LLZO(lithium lanthanum zirconium oxide)/LLZTO(lithium lanthanum zirconium tantalum oxide) ceramics with densities >95%, and/or the like. In some examples, integrated ceramic separator layers on the multilayered cathode act as additional physical impediments against Li-dendrite growth to prevent short circuits.

### Examples, Components, and Alternatives

The following sections describe selected aspects of illustrative electrochemical cells having lithium metal anodes and multilayered cathodes as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. First Illustrative Electrochemical Cell

This section describes an illustrative electrochemical cell, such as an electrochemical cell in accordance with the present teachings. The electrochemical cell may be any bipolar electrochemical device, such as a battery (e.g., lithium-ion battery, secondary battery).

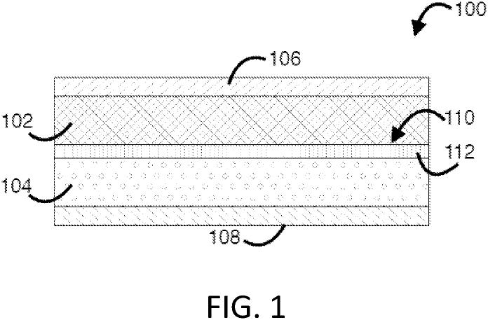

Referring now to FIG. 1, an electrochemical cell 100 is illustrated schematically in the form of a lithium-ion battery. Electrochemical cell 100 includes a positive and a negative electrode, namely a cathode 102 and an anode 104. The cathode and anode are sandwiched between a pair of current collectors 106, 108, which may comprise metal foils or other suitable substrates. Current collector 106 is electrically coupled to cathode 102, and current collector 108 is electrically coupled to anode 104. In some examples, current collector 106 comprises aluminum foil and current collector 108 comprises copper foil. In some examples, the anode 104 comprises lithium metal laminated onto the copper foil current collector. In some examples, current collector 108 comprises Li-Mg foil and anode 104 comprises lithium metal alloyed with the current collector. The current collectors enable the flow of electrons, and thereby electrical current, into and out of each electrode. An electrolyte 110 disposed throughout one or both of the electrodes enables the transport of ions between cathode 102 and anode 104. Electrolyte 110 facilitates an ionic connection between cathode 102 and anode 104.

Electrolyte 110 is assisted by a separator 112, which physically partitions the space between cathode 102 and anode 104. Separator 112 enables the movement (flow) of ions between the two electrodes and insulates the two electrodes from each other. In some examples, separator 112 comprises a solid ion conducting material. Separator 112 may prevent dendritic growth through the electrochemical cell. In some examples, separator 112 is a porous polyolefin film permeated with liquid electrolyte. In some examples, the separator is a solid oxide-based lithium ion conductor, such as garnet-type LLZO(lithium lanthanum zirconium oxide)/LLZTO(lithium lanthanum zirconium tantalum oxide) ceramics with densities >95%, and/or the like. As described further below, separator 112 may be integrated within one or both of cathode 102 and anode 104. In some embodiments, for example, separator 112 comprises a layer of ceramic particles (e.g., sulfide ceramic particles) applied to a top surface of cathode 102, such that the ceramic particles of separator 112 are interpenetrated or intermixed with active material particles of cathode 102 or anode 104.

Cathode 102 is a composite structure, which comprises active material particles, binders, conductive additives, and pores (void space) into which electrolyte 110 may penetrate. An arrangement of the constituent parts of an electrode is referred to as a microstructure, or more specifically, an electrode microstructure.

In some examples, the binder is a polymer, e.g., polyvinylidene difluoride (PVdF), and the conductive additive typically includes a nanometer-sized carbon, e.g., carbon black or graphite. In some examples, the binder is a mixture of carboxyl-methyl cellulose (CMC) and styrene-butadiene rubber (SBR). In some examples, the conductive additive includes a ketjen black, a graphitic carbon, a low dimensional carbon (e.g., carbon nanotubes), and/or a carbon fiber.

Cathode 102 may comprise any suitable active material particles. For example, cathode 102 may include transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides, chalcogenides, and/or the like. In some examples, cathode 102 includes lithium-containing transition metal oxides, such as lithium nickel cobalt aluminum oxide (NCA), lithium nickel cobalt manganese oxide (NMC), lithium iron phosphate (LFP), lithium manganese oxide (LMO), Itihium nickel manganese spinel (LNMO), lithium cobalt oxide (LCO), lithium titanate (LTO), lithium nickel manganese oxide (NMO), and/or the like.

In an electrochemical device, active materials participate in an electrochemical reaction or process with a working ion to store or release energy. For example, in a lithium-ion battery, the working ions are lithium ions. As described above, anode 104 comprises lithium metal. Accordingly, the working lithium ions are alloyed with the anode current collector when the electrochemical cell is charged and stored within the cathode active material particles when the electrochemical cell is discharged.

Electrochemical cell 100 may include packaging (not shown). For example, packaging (e.g., a prismatic can, stainless steel tube, polymer pouch, etc.) may be utilized to constrain and position cathode 102, anode 104, current collectors 106 and 108, electrolyte 110, and separator 112.

For electrochemical cell 100 to properly function as a secondary battery, active material particles in both cathode 102 and anode 104 must be capable of storing and releasing lithium ions through the respective processes known as lithiating and delithiating. Some active materials (e.g., layered oxide materials, graphitic carbon, etc.) fulfill this function by intercalating lithium ions between crystal layers or within interstitial spaces within a crystal lattice. Other active materials may have alternative lithiating and delithiating mechanisms (e.g., alloying, conversion).

When electrochemical cell 100 is being charged, anode 104 accepts lithium ions while cathode 102 donates lithium ions. When a cell is being discharged, anode 104 donates lithium ions while cathode 102 accepts lithium ions. Each electrode (i.e., cathode 102 and anode 104) has a rate at which it donates or accepts lithium ions that depends upon properties extrinsic to the electrode (e.g., the current passed through each electrode, the conductivity of the electrolyte 110) as well as properties intrinsic to the electrode (e.g., the solid state diffusion constant of the active material particles in the electrode; the electrode microstructure or tortuosity; the charge transfer rate at which lithium ions move from being solvated in the electrolyte to being intercalated in the active material particles of the electrode; etc).

During either mode of operation (charging or discharging) anode 104 or cathode 102 may donate or accept lithium ions at a limiting rate, where rate is defined as lithium ions per unit time, per unit current. For example, during charging, anode 104 may accept lithium at a first rate, and cathode 102 may donate lithium at a second rate. When the second rate is lesser than the first rate, the second rate of the cathode would be a limiting rate. In some examples, the differences in rates may be so dramatic as to limit the overall performance of the lithium-ion battery (e.g., cell 100). Reasons for the differences in rates may depend on an energy required to lithiate or delithiate a quantity of lithium-ions per mass of active material particles; a solid state diffusion coefficient of lithium ions in an active material particle; and/or a particle size distribution of active material within a composite electrode. In some examples, additional or alternative factors may contribute to the electrode microstructure and affect these rates.

### B. Second Illustrative Electrochemical Cell

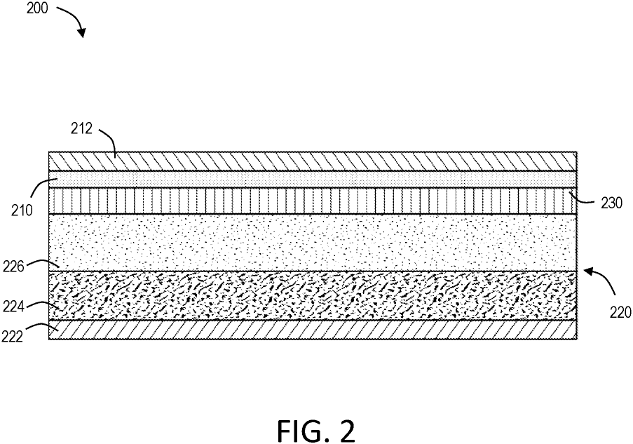

As shown in FIG. 2, this section describes a second illustrative electrochemical cell 200 having a lithium metal anode 210 and a multilayered cathode 220. Electrochemical cell 200 includes an anode current collector 212 electrically coupled to lithium metal anode 210. Anode current collector 212 may comprise any suitable metal foil for use as an anode current collector, such as copper foil, Li-Mg foil (which may alloy with the lithium metal), and/or the like. The lithium metal anode comprises a layer of lithium metal disposed between the anode current collector and a separator 230. Separator 230 is disposed between and directly contacting lithium metal anode 210 and multilayered cathode 220, and is configured to electrically insulate the anode and the cathode from each other. Separator 230 may comprise any suitable material which is permeable to Li-ions and electrically insulating, such as a polyolefin separator permeated with electrolyte, a solid-state separator comprising a ceramic oxide material (e.g., LLZO, LLZTO)), and/or the like. Suitable separators 230 have a defect-free separator surface, which provides a smooth interface with the lithium metal anode. Multilayered cathode 220 is electrically coupled to an aluminum cathode current collector 222.

Lithium metal anode 210 comprises a layer of lithium metal disposed between the anode current collector and a separator 230. As the electrochemical cell charges and discharges, a thickness of lithium metal anode 210 may increase and decrease as lithium ions are stored within the multilayered cathode. As the electrochemical cell is charged, lithium metal anode 210 increases in thickness, as lithium ions move from the cathode to the anode. As the electrochemical cell is discharged, lithium metal anode 210 decreases in thickness, as lithium ions move from the anode to the cathode. In some examples, lithium metal anode 210 is laminated onto a copper foil current collector 212. In some examples, lithium metal anode 210 is alloyed with a Li-Mg foil current collector 212.

Multilayered cathode 220 comprises a first cathode layer 224 layered onto and directly contacting the cathode current collector 222, and a second cathode layer 226 layered onto and directly contacting the first cathode layer 224. The first cathode layer 224 and the second cathode layer 226 respectively comprise a first and second active material, which may comprise any suitable transition metal oxide for use in a cathode, such as nickel manganese cobalt oxide (NMC), lithium cobalt oxide (LCO), lithium iron phosphate (LFP), and/or the like. In some examples, the first and second active material comprise a same transition metal oxide. In some examples, the first and second active material comprise different transition metal oxides selected to provide a gradient of electrochemical properties which may provide a beneficial lithiation profile. In some examples, multilayered cathode 220 has a tortuosity gradient wherein a tortuosity closer to the separator is lower than a tortuosity near the current collector. In some examples, multilayered cathode 220 has a porosity gradient wherein a pore volume closer to the separator is higher than a pore volume near the current collector. In some examples, multilayered cathode 220 has a particle size gradient wherein cathode particles near the separator are smaller than cathode particles near the current collector. In some examples, multilayered cathode 220 has a particle size gradient wherein cathode particles near the separator are larger than cathode particles near the current collector. In some examples, multilayered cathode 220 is a composite structure, comprising active material particles, binders, conductive additives, and pores (AKA void space) into which an electrolyte may penetrate.

Pores of multilayered cathode 220 may be permeated with any suitable liquid or gel electrolyte, such as organic carbonate, ionic liquid, solvent-in-salt superconcentrated electrolyte, gel electrolyte, and/or the like. Similarly, in some examples, pores of separator 230 may be permeated with a liquid and/or gel electrolyte, such as organic carbonate, ionic liquid, solvent-in-salt superconcentrated electrolyte, gel electrolyte, and/or the like. In some examples, separator 230 comprises a porous polyolefin film penetrated with a liquid electrolyte. In some examples, separator 230 comprises a solid oxide-based lithium-ion conductor, such as garnet-type LLZO or LLZTO ceramics having densities greater than or equal to 95%, which conducts ions through solid-state diffusion.

### C. Third Illustrative Electrochemical Cell

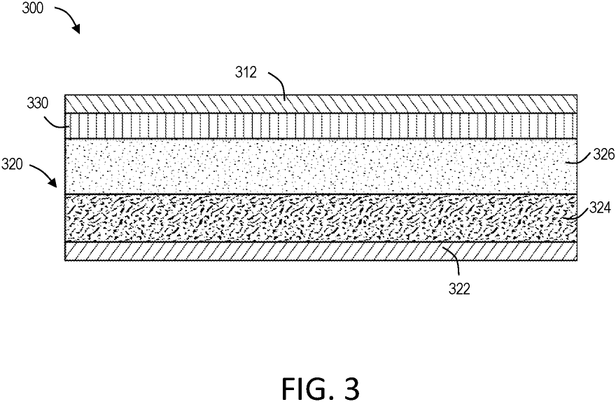

As shown in FIG. 3, this section describes a third illustrative electrochemical cell 300 having a multilayered cathode 320. The electrochemical cell of FIG. 3 is depicted in a discharged state, where all lithium ions are stored within the cathode. Accordingly, electrochemical cell 300 includes an anode current collector 312, which is configured to electrically couple with lithium metal when the electrode is fully and/or partially charged. Anode current collector 312 may comprise any suitable metallic foil, such as copper foil, Li-Mg foil (which may alloy with the lithium metal), and/or the like. A separator 330 is disposed between the anode current collector and the multilayered cathode. Separator 330 may comprise any suitable material which is electrically insulating and allows for the passage of ions, either via diffusion through liquid and/or gel-filled pores or via solid-state diffusion, such as a polyolefin separator permeated with electrolyte, a solid-state separator comprising a ceramic oxide material (e.g., LLZO, LLZTO)), and/or the like. Suitable separators 330 have a defect-free separator surface, which provides a smooth interface with the lithium metal anode. Defects in the separator surface may cause defects (e.g., cavities) in the lithium metal anode when the electrode is charged. Multilayered cathode 320 is electrically coupled to an aluminum cathode current collector 322.

Electrochemical cell 300 is depicted in a discharged state, as described above. Accordingly, electrochemical cell 300 may be described as having an “anode-free” configuration including no excess lithium. All or nearly all lithium ions included in electrochemical cell 300 may be stored in multilayered cathode 320 when the electrochemical cell is depicted in a discharged state. Accordingly, electrochemical cell 300 is transitionable between two states (a) a charged state, and (b) a discharged state. When electrochemical cell 300 is charged, lithium ions stored in multilayered cathode 320 may be electroplated onto the anode current collector (e.g., in the case of a copper foil current collector), alloyed with the anode current collector (e.g., in the case of a Li-Mg foil current collector), or otherwise removed (e.g., intercalated, converted) from the multilayered cathode. When electrochemical cell 300 is discharged, the lithium ions are stored in multilayered cathode 320 and anode current collector 312 contacts separator 330. In some examples, electrochemical cell 300 may experience first-cycle loss of cathode lithium material.

Multilayered cathode 320 comprises a first cathode layer 324 layered onto and directly contacting the cathode current collector 322, and a second cathode layer 326 layered onto and directly contacting the first cathode layer 324. The first cathode layer 324 and the second cathode layer 326 respectively comprise a first and second active material, which may comprise any suitable transition metal oxide for use in a cathode, such as nickel manganese cobalt oxide (NMC), lithium cobalt oxide (LCO), lithium iron phosphate (LFP), and/or the like. In some examples, the first and second active material comprise a same transition metal oxide. In some examples, the first and second active material comprise different transition metal oxides selected to provide a gradient of electrochemical properties which may provide a beneficial lithiation profile. In some examples, multilayered cathode 320 has a tortuosity gradient wherein a tortuosity closer to the separator is lower than a tortuosity near the current collector. In some examples, multilayered cathode 320 has a porosity gradient wherein a pore volume closer to the separator is higher than a pore volume near the current collector. In some examples, multilayered cathode 320 has a particle size gradient wherein cathode particles near the separator are smaller than cathode particles near the current collector. In some examples, multilayered cathode 320 has a particle size gradient wherein cathode particles near the separator are larger than cathode particles near the current collector. In some examples, multilayered cathode 320 is a composite structure, comprising active material particles, binders, conductive additives, and pores (AKA void space) into which an electrolyte may penetrate. Accordingly, multilayered cathode 320 may comprise lithium-rich cathode materials.

Pores of multilayered cathode 320 may be permeated with any suitable liquid or gel electrolyte, such as organic carbonate, ionic liquid, solvent-in-salt superconcentrated electrolyte, gel electrolyte, and/or the like. Similarly, in some examples, pores of separator 330 may be permeated with a liquid and/or gel electrolyte, such as organic carbonate, ionic liquid, solvent-in-salt superconcentrated electrolyte, gel electrolyte, and/or the like. In some examples, separator 330 comprises a porous polyolefin film penetrated with a liquid electrolyte. In some examples, separator 330 comprises a solid oxide-based lithium-ion conductor, such as garnet-type LLZO or LLZTO ceramics having densities greater than or equal to 95%, which conducts ions through solid-state diffusion.

### D. Fourth Illustrative Electrochemical Cell

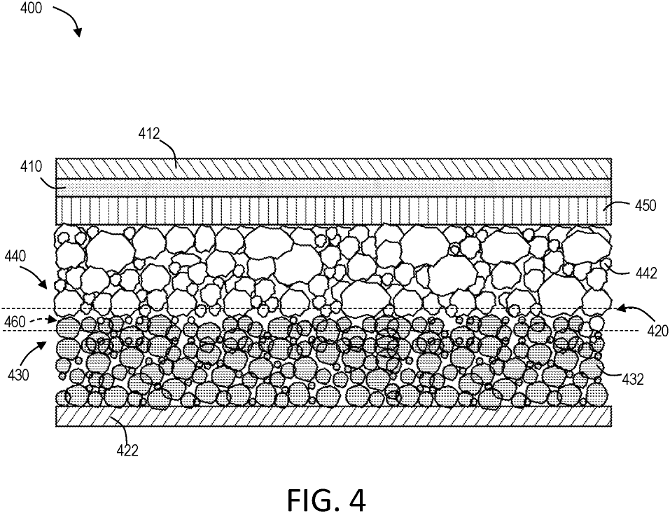

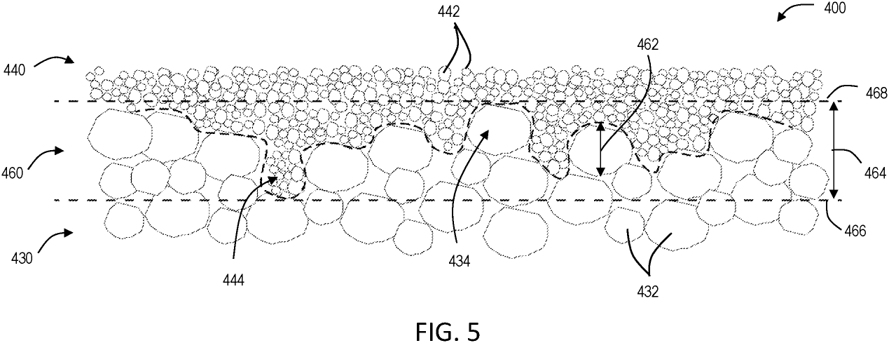

As shown in FIGS. 4-5, this section describes a fourth illustrative electrochemical cell 400 having a lithium metal anode 410 and a multilayered cathode 420. Lithium metal anode 410 and multilayered cathode 420 are insulated from each other by a separator 450 disposed between the anode and the cathode. Electrochemical cell 400 is substantially similar to electrochemical cell 200, except as otherwise described.

Electrochemical cell 400 includes an anode current collector 412 electrically coupled to a lithium metal anode. As described above with respect to electrochemical cells 200 and 300, lithium metal anode 410 comprises a layer of lithium metal laminated onto, electroplated onto, alloyed with, or otherwise disposed on the anode current collector. In some examples, the anode current collector comprises a copper foil and the lithium metal anode is laminated onto the copper foil current collector. In some examples, the anode current collector comprises a Li—Mg foil, and the lithium metal anode is alloyed with the Li—Mg current collector. In some examples, the electrochemical cell has an “anode-free” configuration, as described above with respect to electrochemical cell 300, and the lithium metal anode is electroplated onto a copper current collector when the cell is charged. The lithium ions are stored in the cathode when the cell is in a discharged state.

Multilayered cathode 420 comprises a first cathode active material layer 430 comprising a first plurality of cathode active material particles 432 adhered together by a first binder. First cathode active material layer 430 is layered onto and directly contacting a cathode current collector 422, which comprises any suitable material for a cathode current collector, such as aluminum foil and/or the like. A second cathode active material layer 440 comprising a second plurality of cathode active material particles 442 adhered together by a second binder is layered onto and directly contacting first cathode active material layer 430. As multilayered cathode 420 is a composite structure, first cathode active material layer 430 and second cathode active material layer 440 may further comprise conductive additives and pores (AKA void space) into which an electrolyte may penetrate.

The first plurality of cathode active material particles and the second plurality of cathode active material particles may comprise any suitable cathode active material, such as transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides and/or chalcogenides. In some examples, the first and second pluralities of cathode active material particles comprise transition metal oxides, such as nickel manganese cobalt oxide (NMC), lithium cobalt oxide (LCO), lithium iron phosphate (LFP), and/or the like.

The first plurality of cathode active material particles and the second plurality of cathode active material particles may be selected to provide a desired electrode microstructure within the multilayered cathode. For example, multilayered cathode 420 may have a tortuosity gradient wherein regions of the multilayered cathode closer to the separator have a lower tortuosity than regions of the multilayered cathode closer to the current collector (i.e., the second cathode active material layer has a lower tortuosity than the first cathode active material layer). In some examples, multilayered cathode 420 has a porosity gradient wherein regions of the multilayered cathode closer to the separator have higher pore volumes than regions of the multilayered cathode closer to the current collector (i.e., the second cathode active material layer has a higher pore volume than the first cathode active material layer). In some examples, multilayered cathode 420 has a particle size gradient wherein cathode particles near the separator have smaller particle sizes than cathode particles near the current collector (i.e., the second plurality of cathode active material particles has a smaller average particle size than the first plurality of cathode active material particles). In some examples, multilayered cathode 420 has a particle size gradient wherein cathode particles near the separator have larger particle sizes than cathode particles near the current collector (i.e., the second plurality of cathode active material particles has a larger average particle size than the first plurality of cathode active material particles).

In some examples, an interlocking region 460 may be disposed between and may interlock the first cathode active material layer and the second cathode active material layer (see FIG. 5) Interlocking region 460 includes a non-planar boundary between first cathode active material layer 430 and second cathode active material layer 440. First cathode active material layer 430 and second cathode active material layer 440 have respective, three-dimensional, interpenetrating fingers 434, 444 that interlock the two layers together, forming a mechanically robust interface that is capable of withstanding stresses, such as those due to electrode expansion and contraction. Additionally, the non-planar surfaces defined by fingers 434 and fingers 444 represent an increased total surface area of the interface boundary, which may provide reduced interfacial resistance and may increase ion mobility through the electrode. Fingers 434 and 444 may be interchangeably referred to as fingers, protrusions, extensions, projections, and/or the like. Furthermore, the relationship between fingers 434 and 444 may be described as interlocking, interpenetrating, intermeshing, interdigitating, interconnecting, interlinking, and/or the like.

Fingers 434 and fingers 444 are a plurality of substantially discrete interpenetrations, wherein fingers 434 are generally made up of first active material particles 432 and fingers 444 are generally made up of second active material particles 442. The fingers are three-dimensionally interdigitated, analogous to an irregular form of the stud-and-tube construction of Lego bricks. Accordingly, fingers 434 and 444 typically do not span the electrode in any direction, such that a cross section perpendicular to that of FIG. 5 will also show a non-planar, undulating boundary similar to the one shown in FIG. 5. Interlocking region 460 may alternatively be referred to as a non-planar interpenetration of first cathode active material layer 430 and second cathode active material layer 440, including fingers 434 interlocked with fingers 444.

As shown in FIG. 4, although fingers 434 and 444 may not be uniform in size or shape, the fingers may have an average or typical length 462. In some examples, length 462 of fingers 434 and 444 may be greater than two times the average particle size of the first active material particles or the second active material particles, whichever is smaller. In some examples, length 462 of fingers 434 and 444 may fall in a range between two and five times the average particle size of the first active material particles or the second active material particles, whichever is smaller. In some examples, length 462 of fingers 434, 444 may fall in a range between six and ten times the average particle size of the first active material particles or the second active material particles, whichever is smaller. In some examples, length 462 of fingers 434 and 444 may fall in a range between eleven and fifty times the average particle size of the first active material particles or the second active material particles, whichever is smaller. In some examples, length 462 of fingers 434 and 444 may be greater than fifty times the average particle size of the first active material particles or the second active material particles, whichever is smaller.

In some examples, length 462 of fingers 434 and 444 may be greater than two microns. In some examples, length 462 of fingers 434 and 444 may fall in a range of approximately five hundred to approximately one thousand nanometers. In some examples, length 462 of fingers 434 and 444 may fall in a range of approximately one to approximately five µm. In some examples, length 462 of fingers 434 and 444 may fall in a range between approximately six and approximately ten µm. In another example, length 462 of fingers 434 and 444 may fall in a range between approximately eleven and approximately fifty µm. In another example, length 462 of fingers 434 and 444 may be greater than approximately fifty µm.

In the present example, a total thickness 464 of interlocking region 460 is defined by the level of interpenetration between the two electrode material layers (first active material layer 430 and second active material layer 440). A lower limit 466 may be defined by the lowest point reached by second active material layer 440 (i.e., by fingers 444). An upper limit 468 may be defined by the highest point reached by first active material layer 430 (i.e., by fingers 434). Total thickness 464 of interlocking region 460 may be defined as the separation or distance between limits 466 and 468. In some examples, the total thickness of interlocking region 460 may fall within one or more of various relative ranges, such as between approximately 200% (2x) and approximately 500% (5x), approximately 500% (5x) and approximately 1000% (10x), approximately 1000% (10x) and approximately 5000% (50x), and/or greater than approximately 5000% (50x) of the average particle size of the first active material layer or the ceramic particles, whichever is smaller.

In some examples, total thickness 464 of interlocking region 460 may fall within one or more of various absolute ranges, such as between approximately 500 and one thousand nanometers, one and approximately ten µm, approximately ten and approximately fifty µm, and/or greater than approximately fifty µm.

In the present example, first active material particles 432 and second active material particles 442 are substantially spherical in particle morphology. In other examples, one or both of the plurality of particles in either the first cathode active material layer or the second cathode active material layer may have particle morphologies that are: spherical, flake-like, platelet-like, irregular, potato-shaped, oblong, fractured, agglomerates of smaller particle types, and/or a combination of the above.

When particles of multilayered cathode 420 are lithiating or delithiating, cathode 420 remains coherent, and the first active material layer and the second active material layer remain bound by interlocking region 460. In general, the interdigitation or interpenetration of fingers 434 and 444, as well as the increased surface area of the interphase boundary, function to adhere the two zones together.

During charging of the lithium ion cell, first active material particles 432 and second active material particles 442 delithiate. During this process, the first active material particles and the second active material particles may contract, causing first and second cathode active material layers to contract. In contrast, during discharging of the cell, the active material particles lithiate and swell, causing the active material layers to swell. During both charging and discharging, multilayered cathode 420 may remain coherent, and first active material layer 430 and second active material layer 440 remain bound by interlocking region 460. This bonding of the first and second active material layer may decrease interfacial resistance between the layers and maintain mechanical integrity of an electrochemical cell including the electrode.

Interlocking region 460 may comprise a network of fluid passageways defined by active material particles, binder, conductive additives, and/or additional layer components. These fluid passages are not hampered by calendering-induced changes in mechanical or morphological state of the particles due to the non-planar boundary included in the interlocking region. In contrast, a substantially planar boundary is often associated with the formation of a crust layer upon subsequent calendering. Such a crust layer is disadvantageous as it can significantly impede ion conduction through the interlocking region. Furthermore, such a crust layer also represents a localized compaction of active material particles that effectively result in reduced pore volumes within the electrode.

Pores of multilayered cathode 420 may be filled with a liquid or gel electrolyte, which may carry (i.e., conduct) ions throughout the multilayered cathode. In some examples, the electrolyte comprises an organic carbonate electrolyte having dilute salt concentration, such as 1.0 - 1.5 M LiPF₆ in EC/EMC/DEC/DMC carbonate base solvent with additives, and/or the like. In some examples, the electrolyte comprises an ionic liquid, such as 0.3 M LiTFSI in PY14TFSI(N-butyl-N-methyl-pyrrolidiniumbis(trifluoromethanesulfonyl)imide), and/or the like. In some examples, the electrolyte comprises a solvent-in-salt electrolyte, such as >3 M LiFSI/LiTFSI in DME/DMC, and/or the like. In some examples, the electrolyte comprises local high concentration electrolytes (LHCEs), such as LiFSI/LiTFSI in DME/DMC or TEP (triethyl phosphate) and subsequently diluted with electrochemically inactive fluorinated ethers, such as BTFE (bis(2,2,2,-trifluoroethyl) ether, TFTFE, etc.) In some examples, the electrolyte comprises a gel electrolyte, such as LiPF₆ in EC/EMC/PC/DEC/DMC in PVDF-HFP copolymer matrix, and/or the like.

Suitable separators 450 have a defect-free separator surface, which provides a smooth interface with the lithium metal anode. Defects in the separator surface may cause defects (e.g., cavities) in the lithium metal anode when the electrode is charged. Separator 450 may comprise any suitable material which is electrically insulating and allows for passage of ions through the separator, such as via diffusion through liquid and/or gel-filled pores, solid-state diffusion, and/or the like. In some examples, separator 450 comprises a porous polyolefin film penetrated with a liquid electrolyte. In some examples, separator 450 comprises a solid oxide-based lithium ion conductor, such as garnet-type LLZO or LLZTO ceramics having densities greater than or equal to 95%.

### E. First Illustrative Electrochemical Cell Having an Integrated Ceramic Separator

Operation of an energy storage device under demanding conditions at the limits of an electrode’s capabilities requires accommodating stresses induced by volume expansion (swelling) and contraction during the charging and discharging of battery electrodes. This may lead to structural and functional challenges, as an electrochemical cell including the electrode may have one or more layers, each swelling or contracting at different rates during battery charging and discharging. More specifically, active material layers of electrodes may expand and contract during battery use, while inert separator particles may remain constant in size. Polyolefin separators, commonly used in lithium-ion batteries, may shrink when subject to elevated temperatures, increasing the risk that a battery including the electrode will short circuit during use. A multilayered cathode including an integrated ceramic separator may be resistant to separator shrinkage and short-circuiting. Furthermore, an integrated ceramic separator according to the present disclosure may provide a physical impediment against lithium dendrite growth, preventing short circuits.

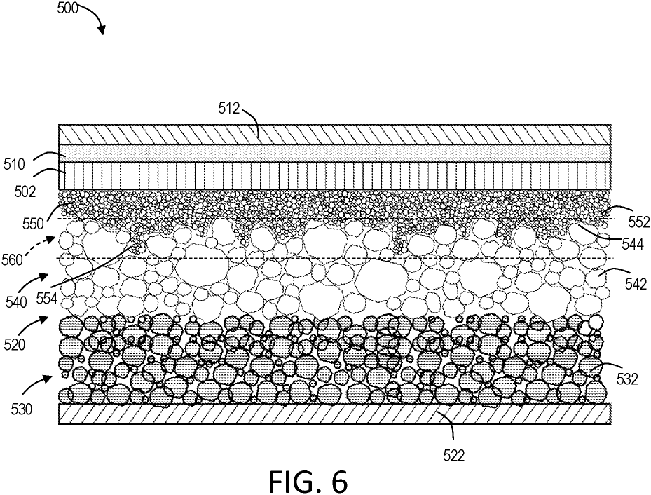

As shown in FIG. 6, this section describes a first illustrative electrochemical cell 500 having an integrated ceramic separator 550. Electrochemical cell 500 includes a lithium metal anode 510, a multilayered cathode 520 including an integrated ceramic separator 550, and a separator 502 disposed between the lithium metal anode and the multilayered cathode.

As described above with respect to electrochemical cells 200, 300, and 400, lithium metal anode 510 comprises a layer of lithium metal laminated onto, electroplated onto, alloyed with, or otherwise disposed on an anode current collector 512. In some examples, anode current collector 512 comprises a copper foil and the lithium metal anode is laminated onto the copper foil current collector. In some examples, the anode current collector comprises a Li—Mg foil, and the lithium metal anode is alloyed with the Li—Mg current collector. In some examples, the electrochemical cell has an “anode-free” configuration, as described above with respect to electrochemical cell 300, and the lithium metal anode is electroplated onto a copper current collector from lithium ions stored in the cathode when the cell is in a discharged state.

Multilayered cathode 520 comprises a first cathode active material layer 530 comprising a first plurality of cathode active material particles 532 adhered together by a first binder. First cathode active material layer 530 is layered onto and directly contacting a cathode current collector 522, which comprises any suitable material for a cathode current collector, such as aluminum foil and/or the like. A second cathode active material layer 540 comprising a second plurality of cathode active material particles 542 adhered together by a second binder is layered onto and directly contacting first cathode active material layer 530. As multilayered cathode 520 is a composite structure, first cathode active material layer 530 and second cathode active material layer 540 may further comprise conductive additives and pores (AKA void space) into which an electrolyte may penetrate.

The first plurality of cathode active material particles and the second plurality of cathode active material particles may be selected to provide a desired electrode microstructure within the multilayered cathode. For example, multilayered cathode 520 may have a tortuosity gradient wherein regions of the multilayered cathode closer to the separator have a lower tortuosity than regions of the multilayered cathode closer to the current collector (i.e., the second cathode active material layer has a lower tortuosity than the first cathode active material layer). In some examples, multilayered cathode 520 has a porosity gradient wherein regions of the multilayered cathode closer to the separator have higher pore volumes than regions of the multilayered cathode closer to the current collector (i.e., the second cathode active material layer has a higher pore volume than the first cathode active material layer). In some examples, multilayered cathode 520 has a particle size gradient wherein cathode particles near the separator have smaller particle sizes than cathode particles near the current collector (i.e., the second plurality of cathode active material particles has a smaller average particle size than the first plurality of cathode active material particles). In some examples, multilayered cathode 520 has a particle size gradient wherein cathode particles near the separator have larger particle sizes than cathode particles near the current collector (i.e., the second plurality of cathode active material particles has a larger average particle size than the first plurality of cathode active material particles).

The first plurality of cathode active material particles and the second plurality of cathode active material particles may comprise any suitable cathode active material, such as transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides and/or chalcogenides. In some examples, the first and second pluralities of cathode active material particles comprise transition metal oxides, such as nickel manganese cobalt oxide (NMC), lithium cobalt oxide (LCO), lithium iron phosphate (LFP), and/or the like.

Multilayered cathode 520 further comprises an integrated ceramic separator layer 550 layered onto and directly contacting second active material layer 540. An interlocking region 560 is disposed between the second active material layer and integrated ceramic separator layer 550. Interlocking region 560 comprises a non-planar boundary between second active material layer 540 and integrated ceramic separator layer 550, configured to decrease interfacial resistance between the layers and to reduce lithium plating on the electrode layer.

Integrated separator layer 550 includes a plurality of ceramic particles 552 adhered together by a third binder. Ceramic particles 552 may comprise any suitable shape for ceramic particles, such as spherical, polyhedral, egg-shaped, coral-shaped, irregular, oblong, and/or the like. Although ceramic particles 552 are referred to as ceramics, particles 552 may comprise any suitable inorganic material or materials, including ceramics such as aluminum oxide (i.e., alumina (α—Al₂O₃)), corundum, calcined, tabular, synthetic boehmite, silicon oxides or silica, zirconia, and/or the like. In some examples, ceramic particles 552 are electrically non-conductive. In some examples, ceramic particles 552 are electrochemically inactive.

Ceramic particles 552 may have a greater hardness than active material particles 532, 542. As a result, separator layer 550 may have a higher resistance to densification and lower compressibility than the active material layers. Integrated separator layer 550 may have any thickness suitable for allowing ionic conduction while electrically insulating the electrode. In some examples, separator layer 550 may have a thickness between one µm and fifty µm.

Integrated separator layer 550 may comprise varying mass fractions of inorganic particles (e.g., ceramic particles), binders and other additives. In some examples, the separator layer is between 50% and 99% inorganic material. In other examples, the separator layer is greater than 99% inorganic material and less than 1% binder. In the examples having greater than 99% inorganic material, the electrode may be manufactured in a similar fashion to electrodes with separator layers having lower percentages of inorganic material, optionally followed by ablation of excess binder during post-processing.

An interlocking region 560 is disposed between second cathode active material layer 540 and integrated ceramic separator layer 550. Interlocking region 560 is substantially identical to interlocking region 460, as described above (see FIG. 5). Interlocking region 560 includes a non-planar boundary between active material layer 540 and separator layer 550. Active material layer 540 and separator layer 550 have respective, three-dimensional, interpenetrating fingers 544 and 554 that interlock the two layers together, forming a mechanically robust interface that is capable of withstanding stresses, such as those due to electrode expansion and contraction. Additionally, the non-planar surfaces defined by fingers 544 and fingers 554 represent an increased total surface area of the interface boundary, which may provide reduced interfacial resistance and may increase ion mobility through the electrode. Fingers 544 and 554 may be interchangeably referred to as fingers, protrusions, extensions, projections, and/or the like. Furthermore, the relationship between fingers 544 and 554 may be described as interlocking, interpenetrating, intermeshing, interdigitating, interconnecting, interlinking, and/or the like.

In the present example, second active material particles 542 in second active material layer 540 have a distribution of volumes which have a greater average than an average volume of ceramic particles 552 in separator layer 550 i.e., a larger average size. In some examples, second active material particles 542 have a collective surface area that is less than the collective surface area of ceramic particles 552.

When particles of multilayered cathode 520 are lithiating or delithiating (i.e., swelling or contracting), multilayered cathode 520 remains coherent, and the second active material layer and the separator layer remain bound by interlocking region 560. In general, the interdigitation or interpenetration of fingers 544 and 554, as well as the increased surface area of the interphase boundary, function to adhere the two zones together.

Interlocking region 560 may comprise a network of fluid passageways defined by active material particles, ceramic particles, binder, conductive additives, and/or additional layer components. These fluid passages are not hampered by calendering-induced changes in mechanical or morphological state of the particles due to the non-planar boundary included in the interlocking region. In contrast, a substantially planar boundary is often associated with the formation of a crust layer upon subsequent calendering. Such a crust layer is disadvantageous as it can significantly impede ion conduction through the interlocking region. Furthermore, such a crust layer also represents a localized compaction of active material particles that effectively result in reduced pore volumes within the electrode. This has a very large detrimental impact on the rate capability of cathodes.

Pores of multilayered cathode 520 and integrated ceramic separator 550 may be filled with a liquid or gel electrolyte, which may carry ions throughout the multilayered cathode and the integrated ceramic separator. In some examples, the electrolyte comprises an organic carbonate electrolyte having dilute salt concentration, such as 1.0 - 1.5 M LiPF₆ in EC/EMC/DEC/DMC carbonate base solvent with additives, and/or the like. In some examples, the electrolyte comprises an ionic liquid, such as 0.3 M LiTFSI in PY14TFSI(N-butyl-N-methyl-pyrrolidiniumbis(trifluoromethanesulfonyl)imide), and/or the like. In some examples, the electrolyte comprises a solvent-in-salt electrolyte, such as >3 M LiFSI/LiTFSI in DME/DMC, and/or the like. In some examples, the electrolyte comprises local high concentration electrolytes (LHCEs), such as LiFSI/LiTFSI in DME/DMC or TEP (triethyl phosphate) and subsequently diluted with electrochemically inactive fluorinated ethers, such as BTFE (bis(2,2,2,-trifluoroethyl) ether, TFTFE, etc.) In some examples, the electrolyte comprises a gel electrolyte, such as LiPF₆ in EC/EMC/PC/DEC?DMC in PVDF-HFP copolymer matrix, and/or the like.

In some examples, an additional separator 502 is disposed between the integrated ceramic separator and the lithium metal anode. Separator 502 may comprise any suitable material which is electrically insulating and allows for passage of ions through the separator, such as via diffusion through liquid and/or gel-filled pores, solid-state diffusion, and/or the like. In some examples, separator 502 comprises a porous polyolefin film penetrated with a liquid electrolyte. In some examples, separator 502 comprises a solid oxide-based lithium ion conductor, such as garnet-type LLZO or LLZTO ceramics having densities greater than or equal to 95%. Pores of separator 502 may be penetrated with a liquid or gel electrolyte, as described above. In some examples, separator 502 may be configured to fill and/or cover pores or holes in an external surface of integrated ceramic separator 550, providing a smooth interface between the separator and the lithium metal anode.

### F. Second Illustrative Electrochemical Cell Having an Integrated Ceramic Separator

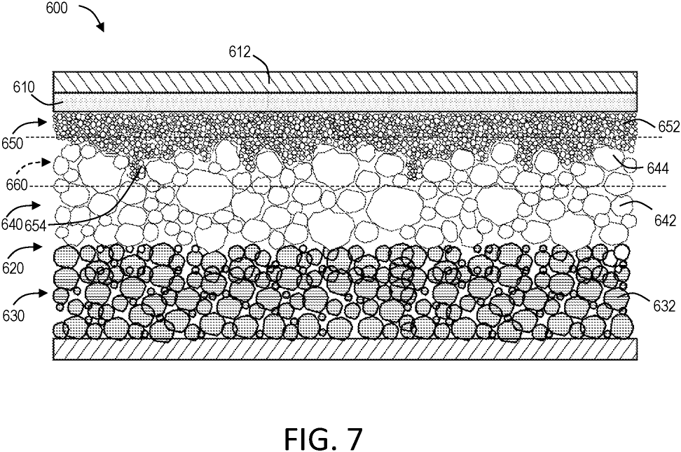

As shown in FIG. 7, this section describes a second illustrative electrochemical cell 600 having an integrated ceramic separator 650. Electrochemical cell 600 includes a lithium metal anode 610 and a multilayered cathode 620 including integrated ceramic separator 650. Electrochemical cell 600 may be substantially identical to electrochemical cell 500, except as otherwise described.

As described above with respect to electrochemical cells 200, 300, 400, and 500, lithium metal anode 610 comprises a layer of lithium metal laminated onto, electroplated onto, alloyed with, or otherwise disposed on an anode current collector 612. In some examples, anode current collector 612 comprises a copper foil and the lithium metal anode is laminated onto the copper foil current collector. In some examples, the anode current collector comprises a Li—Mg foil, and the lithium metal anode is alloyed with the Li—Mg current collector. In some examples, the electrochemical cell has an “anode-free” configuration, as described above with respect to electrochemical cell 300, and the lithium metal anode is electroplated onto a copper current collector from lithium ions stored in the cathode when the cell is in a discharged state.

Multilayered cathode 620 comprises a first cathode active material layer 630 comprising a first plurality of cathode active material particles 632 adhered together by a first binder. First cathode active material layer 630 is layered onto and directly contacting a cathode current collector 622, which comprises any suitable material for a cathode current collector, such as aluminum foil and/or the like. A second cathode active material layer 640 comprising a second plurality of cathode active material particles 642 adhered together by a second binder is layered onto and directly contacting first cathode active material layer 630. As multilayered cathode 620 is a composite structure, first cathode active material layer 630 and second cathode active material layer 640 may further comprise conductive additives and pores (AKA void space) into which an electrolyte may penetrate.

The first plurality of cathode active material particles and the second plurality of cathode active material particles may comprise any suitable cathode active material, such as transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides and/or chalcogenides. In some examples, the first and second pluralities of cathode active material particles comprise transition metal oxides, such as nickel manganese cobalt oxide (NMC), lithium cobalt oxide (LCO), lithium iron phosphate (LFP), and/or the like.

The first plurality of cathode active material particles and the second plurality of cathode active material particles may be selected to provide a desired electrode microstructure within the multilayered cathode. For example, multilayered cathode 420 may have a tortuosity gradient wherein regions of the multilayered cathode closer to the separator have a lower tortuosity than regions of the multilayered cathode closer to the current collector (i.e., the second cathode active material layer has a lower tortuosity than the first cathode active material layer). In some examples, multilayered cathode 420 has a porosity gradient wherein regions of the multilayered cathode closer to the separator have higher pore volumes than regions of the multilayered cathode closer to the current collector (i.e., the second cathode active material layer has a higher pore volume than the first cathode active material layer). In some examples, multilayered cathode 420 has a particle size gradient wherein cathode particles near the separator have smaller particle sizes than cathode particles near the current collector (i.e., the second plurality of cathode active material particles has a smaller average particle size than the first plurality of cathode active material particles). In some examples, multilayered cathode 420 has a particle size gradient wherein cathode particles near the separator have larger particle sizes than cathode particles near the current collector (i.e., the second plurality of cathode active material particles has a larger average particle size than the first plurality of cathode active material particles).

Multilayered cathode 620 further comprises an integrated ceramic separator layer 650 layered onto and directly contacting second active material layer 640. An interlocking region 660 is disposed between the second active material layer and integrated ceramic separator layer 650. Interlocking region 660 comprises a non-planar boundary between second active material layer 640 and integrated ceramic separator layer 650, configured to decrease interfacial resistance between the layers and to reduce lithium plating on the electrode layer. Interlocking region 660 may be substantially identical to interlocking regions 460 and 560, as described above.

Integrated separator layer 650 includes a plurality of ceramic particles 652 adhered together by a third binder. Ceramic particles 652 may comprise any suitable shape for ceramic particles, such as spherical, polyhedral, egg-shaped, coral-shaped, irregular, oblong, and/or the like. Although ceramic particles 652 are referred to as ceramics, particles 652 may comprise any suitable inorganic material or materials, including ceramics such as aluminum oxide (i.e., alumina (α—Al₂O₃)), corundum, calcined, tabular, synthetic boehmite, silicon oxides or silica, zirconia, and/or the like. In some examples, ceramic particles 652 are electrically non-conductive. In some examples, ceramic particles 652 are electrochemically inactive.

Ceramic particles 552 may have a greater hardness than active material particles 632, 642. As a result, separator layer 650 may have a higher resistance to densification and lower compressibility than the active material layers. Integrated separator layer 650 may have any thickness suitable for allowing ionic conduction while electrically insulating the electrode. In some examples, separator layer 650 may have a thickness between one µm and fifty µm.

Integrated separator layer 650 may comprise varying mass fractions of inorganic particles (e.g., ceramic particles), binders and other additives. In some examples, the separator layer is between 50% and 99% inorganic material. In other examples, the separator layer is greater than 99% inorganic material and less than 1% binder. In the examples having greater than 99% inorganic material, the electrode may be manufactured in a similar fashion to electrodes with separator layers having lower percentages of inorganic material, optionally followed by ablation of excess binder during post-processing.

Lithium metal anode 610 and multilayered cathode 620 are separated only by integrated ceramic separator 650. Accordingly, integrated ceramic separator 650 is configured to have a smooth, pinhole free external surface. Pinholes or irregularities in integrated ceramic separator 650 may result in pores within lithium metal anode 610 and/or lithium dendrites, which may short circuit the electrochemical cell if they penetrate through the integrated ceramic separator layer.

### G. Illustrative Method

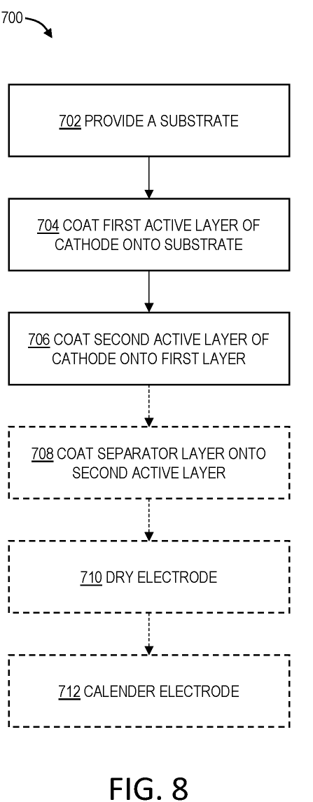

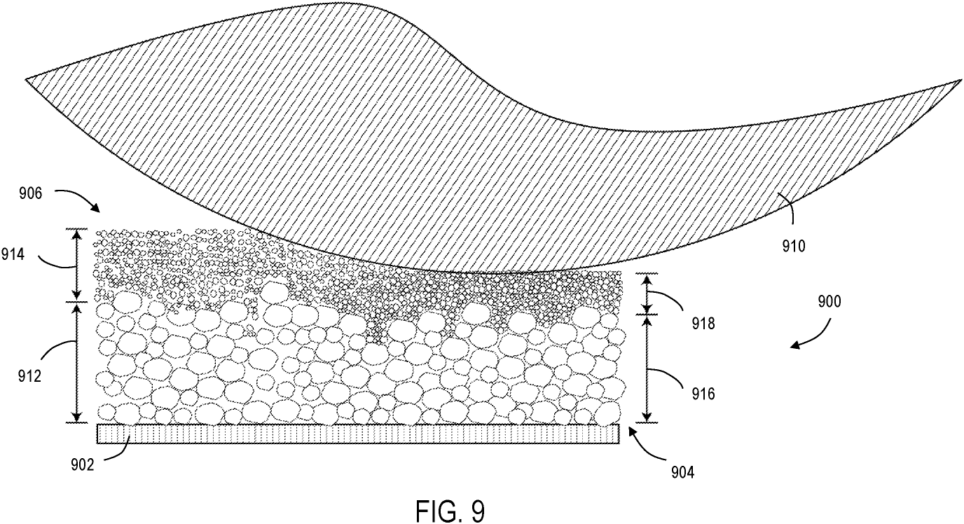

This section describes steps of an illustrative method 700 for manufacturing a multilayered cathode; see FIGS. 8-9. Aspects of electrochemical cells 100, 200, 300, 400, 500, and 600 may be utilized in the method steps described below. Where appropriate, reference may be made to components and systems that may be used in carrying out each step. These references are for illustration, and are not intended to limit the possible ways of carrying out any particular step of the method.

FIG. 8 is a flowchart illustrating steps performed in an illustrative method, and may not recite the complete process or all steps of the method. Although various steps of method 700 are described below and depicted in FIG. 8, the steps need not necessarily all be performed, and in some cases may be performed simultaneously or in a different order than the order shown.

Step 702 of method 700 includes providing a substrate, wherein the substrate includes any suitable structure and material configured to function as a conductor in a secondary battery of the type described herein. In some examples, the substrate comprises a current collector. In some examples, the substrate comprises a metal foil. The term “providing” here may include receiving, obtaining, purchasing, manufacturing, generating, processing, preprocessing, and/or the like, such that the substrate is in a state and configuration for the following steps to be carried out.

Method 700 next includes a plurality of steps in which at least a portion of the substrate is coated with an electrode material composite. This may be done by causing a current collector substrate and an electrode material composite dispenser to move relative to each other, by causing the substrate to move past an electrode material composite dispenser (or vice versa) that coats the substrate as described below. The composition of material particles in each electrode material composite layer may be selected to achieve the benefits, characteristics, and results described herein. The electrode material composite may include one or more electrode layers, including a plurality of active material particles, and one or more separator layers, each including a plurality of inorganic material particles.

Step 704 of method 700 includes coating a first active layer of a composite cathode on a first side of the substrate, forming an active material composite. In some examples, the first active layer may include a plurality of first active material particles adhered together by a first binder, the first particles having a first average particle size (or other first particle distribution). In some examples, the first active material particles may comprise transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides, chalcogenides, and/or the like. In some examples, the first active material particles comprise transition metal oxides, such as nickel manganese cobalt oxide (NMC), lithium cobalt oxide (LCO), lithium iron phosphate (LFP), and/or the like. In some examples, the first binder is a polymer, e.g., polyvinylidene difluoride (PVdF), Teflon (PTFE), and/or the like, and the first conductive additives comprise nanometer-sized carbons, such as carbon black, carbon nanotubes, micron-sized carbon (e.g., flake graphite), and/or the like.

The coating process of step 704 may include any suitable coating method(s), such as slot die, blade coating, spray-based coating, electrostatic jet coating, and/or the like. In some examples, the first layer is coated as a wet slurry of solvent, e.g., water or NMP(N-Methyl-2-pyrrolidone), binder, conductive additive, and active material. In some examples, the first layer is coated dry, as an active material with a binder and/or a conductive additive. In some examples, coating the first layer dry includes spraying the dry coating onto the substrate using any suitable method, such as electrostatically spraying, particle coating, high-velocity spraying, and/or the like. Step 704 may optionally include drying the first layer of the composite cathode.

Step 706 of method 700 includes coating a second active layer of the active material composite onto the first active layer, forming a multilayered (e.g., stratified structure) cathode. In some examples, the second active layer includes a plurality of second active material particles adhered together by a second binder, the second active material particles having a second average particle size (or other second particle distribution). In some examples, the second active material particles may comprise transition metals (for example, nickel, cobalt, manganese, copper, zinc, vanadium, chromium, iron), and their oxides, phosphates, phosphites, and silicates, alkalines and alkaline earth metals, aluminum, aluminum oxides and aluminum phosphates, halides, chalcogenides, and/or the like. In some examples, the second active material particles comprise transition metal oxides, such as nickel manganese cobalt oxide (NMC), lithium cobalt oxide (LCO), lithium iron phosphate (LFP), and/or the like. In some examples, the second binder is a polymer, e.g., polyvinylidene difluoride (PVdF), Teflon (PTFE), and/or the like, and the second conductive additives comprise nanometer-sized carbons, such as carbon black, carbon nanotubes, micron-sized carbon (e.g., flake graphite), and/or the like.

The second layer may be coated using any suitable coating method(s), such as slot die, blade coating, spray-based coating, electrostatic jet coating, and/or the like. In some examples, the second layer is coated as a wet slurry of solvent, e.g., water or NMP(N—Methyl—2—pyrrolidone), binder, additives (e.g., conductive additives), and active material. In some examples, the second layer is coated as a solventless (i.e., dry) layer including a plurality of second active material particles adhered together by a second binder. In some examples, coating the second layer dry includes spraying the dry coating onto the first active material layer using any suitable method, such as electrostatically spraying, particle coating, high-velocity spraying, and/or the like. In some examples, the solventless second layer includes a conductive additive.

The first plurality of cathode active material particles and the second plurality of cathode active material particles may be selected to provide a desired electrode microstructure within the multilayered cathode. For example, the multilayered cathode may have a tortuosity gradient wherein regions of the multilayered cathode closer to the separator have a lower tortuosity than regions of the multilayered cathode closer to the current collector (i.e., the second cathode active material layer has a lower tortuosity than the first cathode active material layer). In some examples, the multilayered cathode has a porosity gradient wherein regions of the multilayered cathode closer to the separator have higher pore volumes than regions of the multilayered cathode closer to the current collector (i.e., the second cathode active material layer has a higher pore volume than the first cathode active material layer). In some examples, the multilayered cathode has a particle size gradient wherein cathode particles near the separator have smaller particle sizes than cathode particles near the current collector (i.e., the second plurality of cathode active material particles has a smaller average particle size than the first plurality of cathode active material particles). In some examples, the multilayered cathode has a particle size gradient wherein cathode particles near the separator have larger particle sizes than cathode particles near the current collector (i.e., the second plurality of cathode active material particles has a larger average particle size than the first plurality of cathode active material particles).

Optional step 708 of method 700 includes optionally coating a separator layer onto the active material composite. The separator layer may include a plurality of ceramic particles adhered together by a third binder, the ceramic particles having a third average particle size. In some examples, the ceramic particles comprise any suitable inorganic material, such as aluminum oxide (i.e., alumina (α—Al₂O₃)), corundum, calcined, tabular, synthetic boehmite, silicon oxides or silica, zirconia, and/or the like. The separator layer may be coated using any suitable coating method(s), such as slot die, blade coating, spray-based coating, electrostatic jet coating, and/or the like. In some examples, the separator layer is coated as a wet slurry of solvent, e.g., water or NMP(N-Methyl-2-pyrrolidone), binder, additives (e.g., conductive additives), and ceramic particles. In some examples, the separator layer is coated as a solventless (i.e., dry) layer including a plurality of ceramic particles adhered together by a third binder. In some examples, coating the separator layer dry includes spraying the dry coating onto the active material composite using any suitable method, such as electrostatically spraying, particle coating, high-velocity spraying, and/or the like.

In some examples, steps 704 and 706 (and optional step 708) may be performed substantially simultaneously. For example, the slurries may be extruded through their respective orifices simultaneously. This forms a two-layer (or three-layer) slurry bead and coating on the moving substrate. In some examples, difference in viscosities, difference in surface tensions, difference in densities, difference in solids contents, and/or different solvents used between the first active material slurry and the second active material slurry or the separator slurry may be tailored to cause interpenetrating finger structures at the boundary between the composite layers. In some embodiments, the viscosities, surface tensions, densities, solids contents, and/or solvents may be substantially similar. Creation of interpenetrating structures, if desired, may be facilitated by turbulent flow at the wet interface between the first active material slurry and the second active material slurry and/or the second active material slurry and the separator slurry, creating partial intermixing of the two slurries. In some examples, the first and second active layers are simultaneously extruded, and the separator layer is coated as a solventless (i.e., dry) layer onto the second layer in a separate step. To facilitate proper curing in the drying process, the first active layer (closest to the current collector) may be configured (in some examples) to be dried from solvent prior to the second active layer (further from the current collector) so as to avoid creating skin-over effects and blisters in the resulting dried coatings. In some examples, the first active layer is coated as a wet slurry onto the substrate and dried, and the second active layer and optional separator layer are coated as solventless layers onto the dried first active layer.

In some examples, the first active layer, the second active layer, and the optional separator layer are extruded simultaneously, e.g., for a total of three layers (more or fewer layers may be present). A triple slot-die coating method may be utilized for triple-layered structures. In some examples, any of the described steps may be repeated to form three or more layers. or Any method described herein to impart structure between the first active layer and the second active layer may be utilized to form similar structures between any additional layers (i.e., the separator layer) deposited during the manufacturing process.

Method 700 may further include drying the composite electrode in step 710. Both the active layers and any separator layers may experience the drying process as a combined structure. In some examples, drying step 710 includes a form of heating and energy transport to and from the electrode (e.g., convection, conduction, radiation) to expedite the drying process. In some examples, drying step 710 includes causing the coated current collector to move relative to a plurality of heating elements. In some examples, drying step 710 includes moving the coated current collector substrate through an oven, furnace, or other enclosed heating environment.

Method 700 may further include calendering the composite electrode in step 712. The active layers and any separator layers may experience the calendering process as a combined structure. In some examples, calendering is replaced with another compression, pressing, or compaction process. In some examples, calendering the electrode may be performed by pressing the combined layers against the substrate, such that electrode density is increased in a non-uniform manner, with the first active layer having a first porosity and the second active layer having a lower second porosity.

In some examples, steps 710 and 712 may be combined (e.g., in a hot roll process).

FIG. 9 shows an electrode undergoing the calendering process, in which particles in a second layer 906 can be calendered with a first layer 904. This may prevent a “crust” formation on the first layer of the electrode. A roller 910 may apply pressure to a fully assembled electrode 900. Electrode 900 may include first layer 904 and second layer 906 applied to a substrate web 902. First layer 904 may have a first uncompressed thickness 912 and second layer 906 may have a second uncompressed thickness 914 prior to calendering. After the electrode has been calendered, first layer 904 may have a first compressed thickness 916 and second layer 906 may have a second compressed thickness 918. In some embodiments, second layer 906 may have a greater resistance to densification and a lower compressibility than first layer 904. After a certain level of densification, a higher tolerance to bulk compression of the second layer may transfer a load to the more compressible electrode layer below. In some examples, an electrode includes three or more layers, and adjacent electrode layers transfer loads to adjacent layers below.

### H. Illustrative Manufacturing System

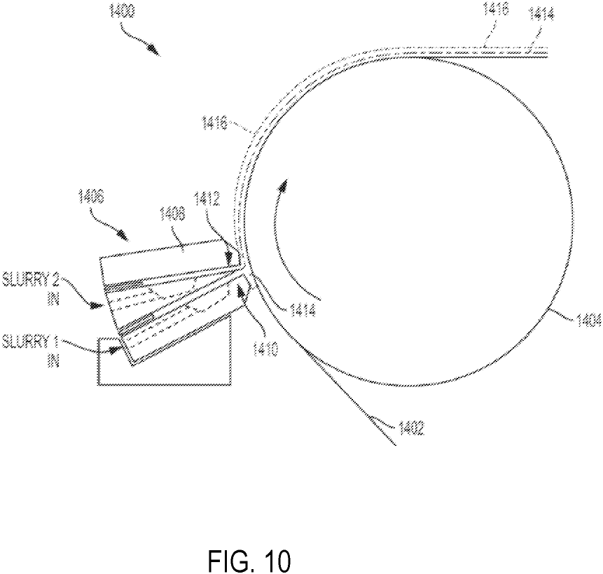

Turning to FIG. 10, an illustrative manufacturing system 1400 for use with method 700 will now be described. In some examples, a slot-die coating head with at least two fluid slots, fluid cavities, fluid lines, and fluid pumps may be used to manufacture a multilayered cathode. In some examples, additional cavities may be used to create additional layers (e.g., an integrated separator).

In system 1400, a foil substrate 1402 is transported by a revolving backing roll 1404 past a stationary dispenser device 1406. Dispenser device 1406 may include any suitable dispenser configured to evenly coat one or more layers of slurry onto the substrate. In some examples, the substrate may be held stationary while the dispenser head moves. In some examples, both may be in motion. Dispenser device 1406 may, for example, include a dual chamber slot die coating device having a coating head 1408 with two orifices 1410 and 1412. A slurry delivery system may supply two different slurries to the coating head under pressure. Due to the revolving nature of backing roll 1404, material exiting the lower orifice or slot 1410 will contact substrate 1402 before material exiting the upper orifice or slot 1412. Accordingly, a first layer 1414 will be applied to the substrate and a second layer 1416 will be applied on top of the first layer. In the present disclosure, the first layer 1414 may be a first active material layer and the second layer may be a second active material layer.

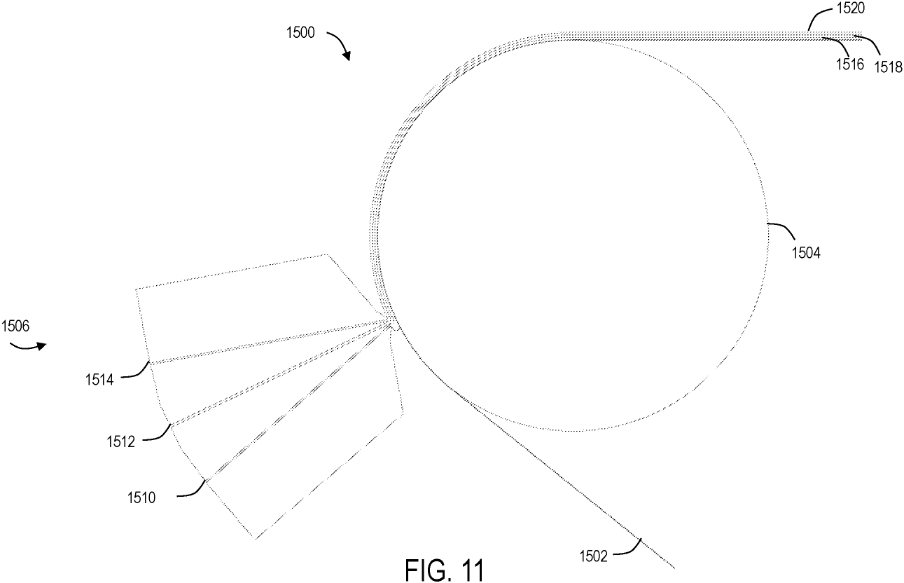

Manufacturing method 700 may be performed using a dual-slot configuration, as described in FIG. 10, to simultaneously extrude the first cathode active material layer and the second cathode active material layer, or a multi-slot configuration with three or more dispensing orifices used to simultaneously extrude a multilayered electrode with an integrated separator layer, as depicted in FIG. 11.

In some examples, a manufacturing system 1500 may include a tri-slot configuration, such that a first active material layer, a second active material layer, and a separator layer may all be extruded simultaneously. In another example, the separator layer may be applied after the multilayered cathode has first dried.

In manufacturing system 1500, a foil substrate 1502 is transported by a revolving backing roll 1504 past a stationary dispenser device 1506. Dispenser device 1506 may include any suitable dispenser configured to evenly coat one or more layers of slurry onto the substrate. In some examples, the substrate may be held stationary while the dispenser head moves. In some examples, both may be in motion. Dispenser device 1506 may, for example, include a three-chamber slot die coating device having a coating head 1508 with three orifices 1510, 1512, and 1514. A slurry delivery system may supply three different slurries to the coating head under pressure. Due to the revolving nature of backing roll 1504, material exiting the lower orifice or slot 1510 will contact substrate 1502 before material exiting the central orifice or slot 1512. Similarly, material exiting central orifice or slot 1512 will contact material exiting lower orifice or slot 1510 before material exiting upper orifice or slot 1514. Accordingly, a first layer 1516 will be applied to the substrate, a second layer 1518 will be applied on top of the first layer, and a third layer 1520 will be applied on top of the second layer.

In some examples, a first active material layer, a second active material layer, and a separator layer may all be extruded simultaneously. In some embodiments, subsequent layers may be applied after initial layers have first dried. In some examples, some or all layers are manufactured in a dry (e.g., solventless) process. In some examples, the first and second active material layers are coated wet simultaneously and dried, and a third separator layer is dry coated onto the second active material layer once the first and second active material layers have been dried.

### I. Illustrative Combinations and Additional Examples

This section describes additional aspects and features of electrochemical cells having lithium metal anodes and multilayer electrodes, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. An electrochemical cell comprising:
an anode including:
   a first current collector, and
   lithium metal, wherein the lithium metal is configured to act as an anode active material,
a cathode including:
   a second current collector,
   a first cathode active material layer layered onto the second current collector, the first cathode active material layer comprising a first plurality of active material particles adhered together by a first binder,
   a second cathode active material layer layered onto the first cathode active material layer, the second cathode active material layer comprising a second plurality of active material particles adhered together by a second binder; and
a separator disposed between the anode and the cathode.

A1. The electrochemical cell of paragraph A0, wherein the first plurality of active material particles comprise nickel manganese cobalt, lithium cobalt oxide, or lithium iron phosphate.

A2. The electrochemical cell of paragraph A0 or A1, wherein the second plurality of active material particles comprise nickel manganese cobalt, lithium cobalt oxide, or lithium iron phosphate.

A3. The electrochemical cell of any of paragraphs A0 through A2, wherein a tortuosity of the second layer is less than a tortuosity of the first layer.

A4. The electrochemical cell of any of paragraphs A0 through A3, wherein a pore volume of the second layer is greater than a pore volume of the first layer.

A5. The electrochemical cell of any of paragraphs A0 through A4, wherein the first plurality of active material particles have an average particle size greater than the second plurality of active material particles.

A6. The electrochemical cell of any of paragraphs A0 through A4, wherein the second plurality of active material particles have an average particle size greater than the first plurality of active material particles.

A7. The electrochemical cell of any of paragraphs A0 through A6, wherein the separator is a porous polyolefin film permeated with liquid electrolyte.

A8. The electrochemical cell of any of paragraphs A0 through A6, wherein the separator is a solid oxide-based lithium-ion conductor.

A9. The electrochemical cell of any of paragraphs A0 through A8, further comprising an integrated ceramic separator layered onto the multilayered cathode, the integrated ceramic separator comprising a plurality of inorganic particles adhered together by a third binder.

A10. The electrochemical cell of paragraph A9, further comprising an interlocking region disposed between and adhering the second cathode active material layer and the integrated ceramic separator.

A11. The electrochemical cell of any of paragraphs A0 through A10, further comprising an interlocking region disposed between and adhering the first cathode active material layer and the second cathode active material layer.

A12. The electrochemical cell of any of paragraphs A0 through A11, wherein the first current collector comprises copper foil.

B0. An electrochemical cell comprising:
a first current collector comprising copper foil;
a second current collector;
a first cathode active material layer layered onto the second current collector, the first cathode active material layer comprising a first plurality of active material particles adhered together by a first binder;
a second cathode active material layer layered onto the first cathode active material layer, the second cathode active material layer comprising a second plurality of active material particles adhered together by a second binder; and
a separator disposed adjacent to the second cathode active material layer;
wherein the electrochemical cell is configured to transition between:
   (a) a charged state, wherein a lithium metal anode layer is electroplated onto the first current collector and disposed between the first current collector and the separator, and
   (b) a discharged state, wherein the first current collector is contacting the separator, and wherein lithium ions reside within the first and second cathode active material layers.

B1. The electrochemical cell of paragraph B0, wherein the first plurality of active material particles comprise nickel manganese cobalt, lithium cobalt oxide, or lithium iron phosphate.

B2. The electrochemical cell of paragraph B0 or B1, wherein the second plurality of active material particles comprise nickel manganese cobalt, lithium cobalt oxide, or lithium iron phosphate.

B3. The electrochemical cell of any of paragraphs B0 through B2, wherein a tortuosity of the second layer is less than a tortuosity of the first layer.

B4. The electrochemical cell of any of paragraphs B0 through B3, wherein a pore volume of the second layer is greater than a pore volume of the first layer.

B5. The electrochemical cell of any of paragraphs B0 through B4, wherein the first plurality of active material particles have an average particle size greater than the second plurality of active material particles.

B6. The electrochemical cell of any of paragraphs B0 through B4, wherein the second plurality of active material particles have an average particle size greater than the first plurality of active material particles.

B7. The electrochemical cell of any of paragraphs B0 through B6, wherein the separator is a porous polyolefin film permeated with liquid electrolyte.

B8. The electrochemical cell of any of paragraphs B0 through B6, wherein the separator is a solid oxide-based lithium-ion conductor.

B9. The electrochemical cell of any of paragraphs B0 through B8, further comprising an integrated ceramic separator layered onto the multilayered cathode, the integrated ceramic separator comprising a plurality of inorganic particles adhered together by a third binder.

B10. The electrochemical cell of paragraph B9, further comprising an interlocking region disposed between and adhering the second cathode active material layer and the integrated ceramic separator.

B11. The electrochemical cell of any of paragraphs B0 through B10, further comprising an interlocking region disposed between and adhering the first cathode active material layer and the second cathode active material layer.

C0. An electrochemical cell comprising:
an anode including a lithium metal anode and a first current collector; and
a cathode including:
   a first cathode active material layer layered onto a second current collector, the first cathode active material layer comprising a first plurality of active material particles adhered together by a first binder;
   a second cathode active material layer layered onto the first cathode active material layer, the second cathode active material layer comprising a second plurality of active material particles adhered together by a second binder; and
   an integrated ceramic separator layer layered onto the second cathode active material layer, the integrated ceramic separator layer comprising a plurality of inorganic ceramic separator particles adhered together by a third binder.

C1. The electrochemical cell of paragraph C0, further comprising a porous polyolefin separator disposed between the cathode and the anode.

C2. The electrochemical cell of paragraph C0, further comprising a solid oxide-based lithium-ion conductor separator disposed between the cathode and the anode.

C3. The electrochemical cell of any of paragraphs C0 through C2, wherein pores of the first cathode active material layer, the second cathode active material layer, and the integrated ceramic separator layer are filled with electrolyte.

C4. The electrochemical cell of any of paragraphs C0 through C3, further comprising an interlocking region disposed between and adhering the second cathode active material layer and the integrated ceramic separator layer.

C5. The electrochemical cell of any of paragraphs C0 through C4, further comprising an interlocking region disposed between and adhering the first cathode active material layer and the second cathode active material layer.

C6. The electrochemical cell of any of paragraphs C0 through C5, wherein the first plurality of active material particles comprise nickel manganese cobalt, lithium cobalt oxide, or lithium iron phosphate.

C7. The electrochemical cell of any of paragraphs C0 through C6, wherein the second plurality of active material particles comprise nickel manganese cobalt, lithium cobalt oxide, or lithium iron phosphate.

C8. The electrochemical cell of any of paragraphs C0 through C7, wherein a tortuosity of the second layer is less than a tortuosity of the first layer.

C9. The electrochemical cell of any of paragraphs C0 through C8, wherein a pore volume of the second layer is greater than a pore volume of the first layer.

C10. The electrochemical cell of any of paragraphs C0 through C9, wherein the first plurality of active material particles have an average particle size greater than the second plurality of active material particles.

C11. The electrochemical cell of any of paragraphs C0 through C10, wherein the second plurality of active material particles have an average particle size greater than the first plurality of active material particles.

### Benefits

The different embodiments and examples of the electrochemical cells described herein provide several advantages over known solutions for providing cells with increased capacity and improved rate performance. For example, illustrative embodiments and examples described herein maximize electrode capacity while minimizing electrode thickness.

No known system or device can perform these functions. However, not all embodiments and examples described herein provide the same advantages or the same degree of advantage.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. An electrochemical cell comprising:
an anode including:
a first current collector, and
lithium metal, wherein the lithium metal is configured to act as an anode active material;
a cathode including:
a second current collector,
a first cathode active material layer layered onto the second current collector, the first cathode active material layer comprising a first plurality of active material particles adhered together by a first binder, and
a second cathode active material layer layered onto the first cathode active material layer, the second cathode active material layer comprising a second plurality of active material particles adhered together by a second binder; and
a separator disposed between the anode and the cathode.

2. The electrochemical cell of claim 1, wherein the first plurality of active material particles comprise nickel manganese cobalt, lithium cobalt oxide, or lithium iron phosphate.

3. The electrochemical cell of claim 2, wherein the second plurality of active material particles comprise nickel manganese cobalt, lithium cobalt oxide, or lithium iron phosphate.

4. The electrochemical cell of claim 1, wherein a tortuosity of the second cathode active material layer is less than a tortuosity of the first cathode active material layer.

5. The electrochemical cell of claim 1, wherein a pore volume of the second cathode active material layer is greater than a pore volume of the first cathode active material layer.

6. The electrochemical cell of claim 1, wherein the separator is a porous polyolefin film permeated with liquid electrolyte.

7. The electrochemical cell of claim 1, further comprising an integrated ceramic separator layered onto the cathode, the integrated ceramic separator comprising a plurality of inorganic particles adhered together by a third binder.

8. An electrochemical cell comprising:
a first current collector comprising copper foil;
a second current collector;
a first cathode active material layer layered onto the second current collector, the first cathode active material layer comprising a first plurality of active material particles adhered together by a first binder;
a second cathode active material layer layered onto the first cathode active material layer, the second cathode active material layer comprising a second plurality of active material particles adhered together by a second binder; and
a separator disposed adjacent to the second cathode active material layer;
wherein the electrochemical cell is configured to transition between:
(a) a charged state, wherein a lithium metal anode layer is electroplated onto the first current collector and disposed between the first current collector and the separator, and
(b) a discharged state, wherein the first current collector is contacting the separator, and wherein lithium ions reside within the first and second cathode active material layers.

9. The electrochemical cell of claim 8, wherein the first plurality of active material particles comprise nickel manganese cobalt, lithium cobalt oxide, or lithium iron phosphate.

10. The electrochemical cell of claim 8, wherein the second plurality of active material particles comprise nickel manganese cobalt, lithium cobalt oxide, or lithium iron phosphate.

11. The electrochemical cell of claim 8, wherein a tortuosity of the second cathode active material layer is less than a tortuosity of the first cathode active material layer.

12. The electrochemical cell of claim 8, wherein the separator is a porous polyolefin film permeated with liquid electrolyte.

13. The electrochemical cell of claim 8, further comprising an integrated ceramic separator layered onto the cathode, the integrated ceramic separator comprising a plurality of inorganic particles adhered together by a third binder.

14. An electrochemical cell comprising:
an anode including a lithium metal anode and a first current collector; and
a cathode including:
a first cathode active material layer layered onto a second current collector, the first cathode active material layer comprising a first plurality of active material particles adhered together by a first binder;
a second cathode active material layer layered onto the first cathode active material layer, the second cathode active material layer comprising a second plurality of active material particles adhered together by a second binder; and
an integrated ceramic separator layer layered onto the second cathode active material layer, the integrated ceramic separator layer comprising a plurality of inorganic ceramic separator particles adhered together by a third binder.

15. The electrochemical cell of claim 14, further comprising a porous polyolefin separator disposed between the cathode and the anode.

16. The electrochemical cell of claim 14, further comprising a solid oxide-based lithium-ion conductor separator disposed between the cathode and the anode.

17. The electrochemical cell of claim 14, wherein pores of the first cathode active material layer, the second cathode active material layer, and the integrated ceramic separator layer are filled with electrolyte.

18. The electrochemical cell of claim 14, further comprising an interlocking region disposed between and adhering the second cathode active material layer and the integrated ceramic separator layer.

19. The electrochemical cell of claim 14, further comprising an interlocking region disposed between and adhering the first cathode active material layer and the second cathode active material layer.

20. The electrochemical cell of claim 14, wherein a tortuosity of the second cathode active material layer is less than a tortuosity of the first cathode active material layer.
